(19) United States
(12) Patent Application Publication
(10) Pub. No.: US 2020/0339079 A1
(43) Pub. Date: Oct. 29, 2020

(54) VEHICLE CONTROL DEVICE, METHOD AND COMPUTER PROGRAM PRODUCT

(71) Applicant: Mazda Motor Corporation, Hiroshima (JP)

(72) Inventor: Hiroshi OHMURA, Aki-gun (JP)

(73) Assignee: Mazda Motor Corporation, Hiroshima (JP)

(21) Appl. No.: 16/819,187

(22) Filed: Mar. 16, 2020

(30) Foreign Application Priority Data
Apr. 24, 2019 (JP) 2019-082575

(51) Int. Cl. B60T 7/22; B60R 21/013; B60T 8/172

(52) U.S. Cl. CPC B60T 7/22; B60R 21/013; B60T 2210/32; B60T 2201/083; B60T 8/172

(57) ABSTRACT

A vehicle control device includes a crossing vehicle detection sensor configured to detect a crossing vehicle approaching an own vehicle while the own vehicle is traveling in an intersecting lane, the intersecting lane being a lane that intersects an own vehicle lane at an intersection at a time the own vehicle approaches the intersection, the crossing vehicle being a vehicle travelling in the intersecting lane; and a controller configured to automatically brake the own vehicle to avoid a collision between the own vehicle and the crossing vehicle under a condition that the own vehicle enters the intersecting lane. The controller is configured to set, between the own vehicle and the crossing vehicle, a virtual area that moves with the crossing vehicle and that extends in an advancing direction of the crossing vehicle, and automatically brakes the own vehicle to prevent the own vehicle from contacting the virtual area.

### CROSS-REFERENCE TO RELATED APPLICATION

The present application claims priority to JP 2019-082575, filed Apr. 24, 2019, the entire contents of which are incorporated herein by reference.

### BACKGROUND

### Field of the Disclosure

The present disclosure relates to a vehicle control device which assists traveling of a vehicle.

### Description of the Related Art

Conventionally, to avoid a collision between an own vehicle (i.e., the subject vehicle) and a predetermined object (a preceding vehicle, a pedestrian, an obstacle or the like) around the own vehicle, a technique relating to an automatic brake for causing the own vehicle to be automatically braked has been proposed. For example, Japanese Patent Laid-Open No. 2018-95097 (patent document 1) discloses a technique where the crossing position of the travel locus of the own vehicle and the travel locus of an oncoming vehicle is acquired, and the automatic brake is controlled corresponding to the time required for the own vehicle to arrive at this crossing position. Further, for example, Japanese Patent Laid-Open No. 2018-197964 (patent document 2) discloses a technique where a virtual stop line is set on map data based on stop positions of a plurality of vehicles, and an automatic brake is controlled such that the vehicle is caused to stop at this virtual stop line.

### SUMMARY OF THE DISCLOSURE

In the conventional technique, to avoid a collision between an own vehicle and an oncoming vehicle when the own vehicle traverses an opposite lane, the automatic brake is controlled basically based on a possibility of a direct collision of the own vehicle with the oncoming vehicle (typically, Time to Collision (TTC) where the own vehicle collides with the oncoming vehicle). However, conventionally, as recognized by the present inventor, there has been no technique where, when the own vehicle enters an intersecting lane (that is, a lane intersecting with an own-vehicle lane at an intersection), a virtual object which corresponds to a crossing vehicle (that is, a vehicle traveling in the intersecting lane) is set, and the automatic brake is controlled not based on the crossing vehicle, but based on this virtual object. That is, there is no technique where the automatic brake is controlled such that the own vehicle is prevented from coming into contact with the virtual object, thus avoiding a collision between the own vehicle and the crossing vehicle eventually. If the automatic brake is controlled based on the virtual object which corresponds to the crossing vehicle as described above, it can be considered that a collision between the own vehicle and the crossing vehicle can be effectively avoided when the own vehicle enters the intersecting lane.

In the technique disclosed in patent document 2, a virtual stop line is set. However, the object of this technique is to specify a specific stop position, where the own vehicle should be caused to stop, on map data, but is not to avoid a collision between the own vehicle and a crossing vehicle when the own vehicle enters an intersecting lane.

The present disclosure has been made to overcome the above-mentioned and other problems, and it is an object of the present disclosure to provide a vehicle control device which can effectively avoid a collision between the own vehicle and the crossing vehicle by causing the own vehicle to be automatically braked based on a virtual area corresponding to a crossing vehicle, when the own vehicle enters an intersecting lane.

To achieve the above-mentioned and other objects, the present disclosure is directed to a vehicle control device (as well as a method and non-transitory computer readable medium) that includes a crossing vehicle detection sensor configured to detect a crossing vehicle approaching an own vehicle while the own vehicle is traveling in an intersecting lane, the intersecting lane being a lane that intersects an own vehicle lane at an intersection at a time the own vehicle approaches the intersection, the crossing vehicle being a vehicle travelling in the intersecting lane; and a controller configured to automatically brake the own vehicle to avoid a collision between the own vehicle and the crossing vehicle under a condition that the own vehicle enters the intersecting lane. The controller is configured to set, between the own vehicle and the crossing vehicle, a virtual area that moves with the crossing vehicle and that extends in an advancing direction of the crossing vehicle, and automatically brakes the own vehicle to prevent the own vehicle from contacting the virtual area.

According to this configuration, the controller sets the virtual area. The virtual area is set to avoid a collision between the own vehicle and the crossing vehicle, and the virtual area forms an application object of a control of causing the own vehicle to be automatically braked.

Specifically, the controller sets, between the own vehicle and the crossing vehicle, the virtual area which moves with advance of the crossing vehicle and which extends in the advancing direction of the crossing vehicle, and the controller performs a control of causing the own vehicle to be automatically braked to prevent the own vehicle from contacting with the virtual area. With such a configuration, it is possible to cause the own vehicle to be stopped at a position relatively separated from the crossing vehicle to avoid a collision between the own vehicle and the crossing vehicle.

In the present disclosure, the controller is configured to set the virtual area having a length which corresponds to a time required for the own vehicle to finish passing through the intersecting lane in which the crossing vehicle travels, or a time required for the own vehicle to finish merging into the intersecting lane in which the crossing vehicle travels. To “merge” means to travel in the advancing direction specified in the intersecting lane.

The own vehicle which finishes passing through the intersecting lane or the own vehicle which finishes merging into the intersecting lane can avoid a collision with a crossing vehicle. That is, “a time required for the own vehicle to finish passing through the intersecting lane where the crossing vehicle travels, or a time required for the own vehicle to finish merging into the intersecting lane where the crossing vehicle travels” means the time required for the own vehicle to finish moving to a position where a collision with the crossing vehicle can be avoided.

According to the above-mentioned configuration, the controller can set the length of the virtual area to a value which corresponds to the time required for the own vehicle to finish moving to a position where a collision with the crossing vehicle can be avoided. By setting the virtual area having such a length, it is possible to avoid a collision between the own vehicle and the crossing vehicle with certainty.

In the present disclosure, the controller is configured to set the length of the virtual area based on a distance obtained by multiplying a speed of the crossing vehicle by the time required for the own vehicle to finish passing through the intersecting lane where the crossing vehicle travels, or the time required for the own vehicle to finish merging into the intersecting lane where the crossing vehicle travels.

According to this configuration, the controller can set the length of the virtual area to a value which corresponds to the time required for the own vehicle to finish moving to a position where a collision with the crossing vehicle can be avoided, and which corresponds to the speed of the crossing vehicle. By setting the virtual area having such a length, it is possible to avoid a collision between the own vehicle and the crossing vehicle with certainty.

In the present disclosure, the controller is configured to automatically brake the own vehicle to prevent the own vehicle from entering the intersection.

According to this configuration, it is possible to dispose the own vehicle at a safer position while a collision between the own vehicle and the crossing vehicle is avoided.

In the present disclosure, the controller is configured to set a plurality of sampling points along an intended path of the own vehicle at predetermined intervals and, based on at least one of the plurality of sampling points and the virtual area, automatically brake the own vehicle to prevent the own vehicle from contacting with the virtual area, and set a width of the virtual area larger than the predetermined interval.

In the vehicle traveling assist, a plurality of sampling points are generally set along the intended path of the vehicle (that is, a path through which the vehicle passes in the future). That is, an intended path formed of continuous curves or the like is treated as discrete sections. Accordingly, the plurality of sampling points are set along the intended path at predetermined intervals, and the state of the vehicle is detected at each sampling point, and the engine and the brake of the vehicle are controlled.

According to the above-mentioned configuration, the sampling points are used in a control of causing the own vehicle to be automatically braked to prevent the own vehicle from contacting with the virtual area, and the width of the virtual area is set larger than the predetermined interval at which the plurality of sampling points are set. With such setting, even in the case where the intended path extends in the width direction of the virtual area, based on the sampling points and the virtual area, it is possible to detect that the intended path of the vehicle is present on the virtual area and hence, a collision between the own vehicle and the crossing vehicle can be avoided with certainty.

In the present disclosure, the vehicle control device includes a direction indicator detection sensor configured to detect flashing of a direction indicator of the crossing vehicle, wherein

the controller is configured to not set the virtual area in a condition where the direction indicator detection sensor detects flashing of the direction indicator of the crossing vehicle.

In the case where the crossing vehicle is flashing the direction indicator, it is anticipated that the crossing vehicle turns left or turns right thereafter. In this case, a possibility of a collision of the own vehicle with the crossing vehicle is relatively low.

According to the above-mentioned configuration, the controller does not set the virtual area when a possibility of an actual collision of the own vehicle with the crossing vehicle is low as described above. With such a configuration, it is possible to avoid a collision between the own vehicle and the crossing vehicle while inhibiting that the own vehicle is unnecessarily automatically braked.

According to the vehicle control device of the present disclosure, it is possible to effectively avoid a collision between the own vehicle and the crossing vehicle by causing the own vehicle to be automatically braked based on the virtual area, which corresponds to the crossing vehicle, when the own vehicle enters the intersecting lane.

### BRIEF DESCRIPTION OF THE DRAWINGS

FIG. 1 is a block diagram showing a schematic configuration of a vehicle control device according to an embodiment;

FIG. 2 is an explanatory view of an automatic brake control according to the embodiment;

FIG. 3 is an explanatory view of the automatic brake control according to the embodiment;

FIG. 4 is an explanatory view of the automatic brake control according to the embodiment;

FIG. 5 is a flowchart showing a process performed by a controller according to the embodiment; and

FIG. 6 is a block diagram of computer-based circuitry that may be used to implement control features of the present disclosure.

### DETAILED DESCRIPTION OF THE EMBODIMENTS

Hereinafter, a vehicle control device according to an embodiment will be described with reference to attached drawings.

### Configuration of Vehicle Control Device

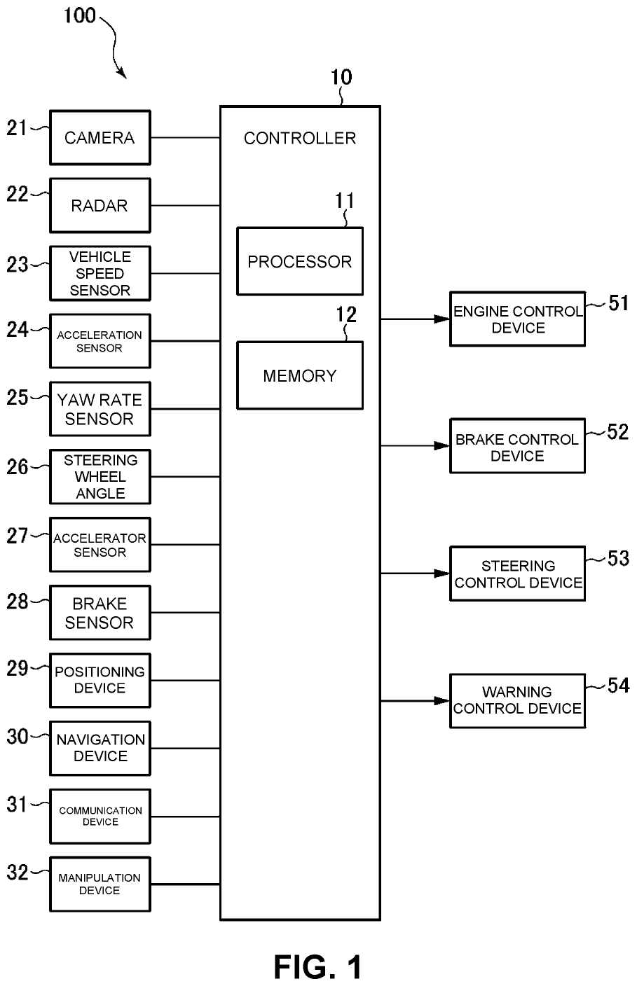

First, the configuration of a vehicle control device 100 according to an embodiment will be described with reference to FIG. 1. FIG. 1 is a block diagram showing a schematic configuration of the vehicle control device 100 according to the embodiment.

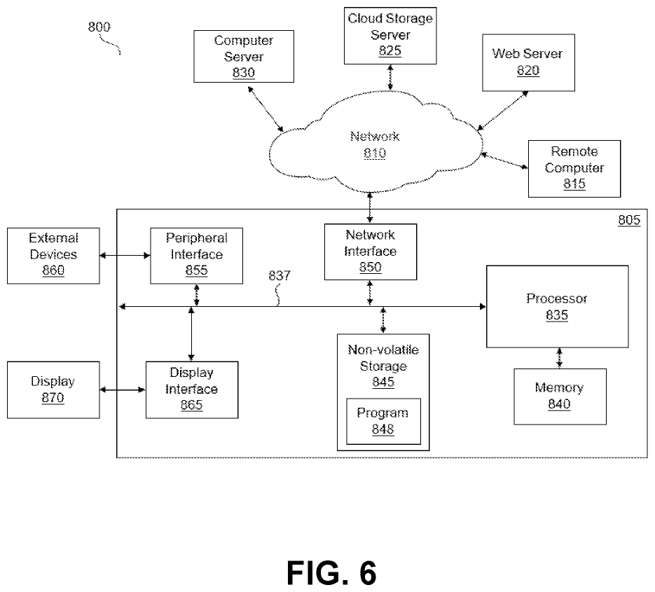

As shown in FIG. 1, the vehicle control device 100 mainly includes a controller 10, such as an ECU (Electronic Control Unit), a plurality of sensors and switches, and a plurality of control devices. This vehicle control device 100 is mounted on a vehicle, and performs various controls to assist traveling of the vehicle. Optionally, the ECU may include the processor 835 and other circuitry in system 800 of FIG. 6, which may be implemented as a single processor-based system, or a distributed processor based system, including remote processing, such as cloud based processing.

The plurality of sensors and switches include a camera 21, (having an image sensor that takes fixed and/or moving images in the visual spectrum and/or non-visual ranges such as infrared and ultraviolet), a radar and/or Lidar 22 (short-range radars, SRR, that operate, for example, in the 20 GHz to 27 GHz range, long range radars, LRR, operating, for example, in the 76 to 81 GHz range, as well as Lidar that operates in at least one of ultraviolet, visible, and near infrared spectrums using lasers having a principle wavelength, for example, in a range of 500 nm to 1000 nm), a plurality of behavior sensors (a vehicle speed sensor 23, an acceleration sensor 24 (example acceleration sensors employ a signal processor connected to a micromechanical comb structure that forms a capacitor with a capacitance set by the spatial distances between comb teeth. When subject to acceleration, relative displacement of comb teeth creates a capacitive change, which is sensed by the signal processor. Piezoelectric, piezoresistive and micro electro-mechanical system (MEMS) sensors may be used as well), a yaw rate sensor 25) which detect behavior of the vehicle and a plurality of behavior switches (a steering wheel angle sensor 26, an accelerator sensor 27, a brake sensor 28), a positioning device 29, a navigation device 30, a communication device 31, and a manipulation device 32. Further, the plurality of control devices include an engine control device 51, a brake control device 52, a steering control device 53, and a warning control device 54, a radar 22, a plurality of behavior sensors (a vehicle speed sensor 23, an acceleration sensor 24, a yaw rate sensor 25) which detect behavior of the vehicle, a plurality of behavior switches (a steering wheel angle sensor 26, an accelerator sensor 27, a brake sensor 28), a positioning device 29, a navigation device 30, a communication device 31, and a manipulation device 32. Further, the plurality of control devices include an engine control device 51, a brake control device 52, a steering control device 53, and a warning control device 54.

The controller 10 is formed of a processor 11, a memory 12, which stores various programs executed by the processor 11, and a computer device including an input/output device and the like. The controller 10 is configured such that, based on signals received from the above-mentioned plurality of sensors and switches, the controller 10 can output control signals for appropriately operating an engine device, a braking device, a steering device, and a warning device to the engine control device 51, the brake control device 52, the steering control device 53, and the warning control device 54. Particularly, in this embodiment, the controller 10 is configured as follows. The controller 10 controls a braking device via the brake control device 52 to avoid a collision between the own vehicle, on which the controller 10 is mounted, and a predetermined object (for example, a crossing vehicle, a preceding vehicle, a pedestrian, an obstacle or the like) around this own vehicle, thus causing the own vehicle to be automatically braked, that is, causing an automatic brake to be operated.

The camera 21 photographs an area around the vehicle (typically, an area in front of the vehicle, and/or an area in a traveling direction of the vehicle, and/or an area in a traveling direction of the vehicle), and outputs image data. The controller 10 identifies various objects based on the image data received from the camera 21. For example, the controller 10 identifies a preceding vehicle, a crossing vehicle, parked vehicles, motorcycles, pedestrians, the traveling road, division lines (a center line, lane boundary lines, white lines, yellow lines), the traffic zone and the traffic division of a lane, traffic lights, traffic signs, stop lines, intersections, obstacles and the like. Based on image data received from the camera 21, the controller 10 also identifies flashing of the direction indicator or a headlamp of a crossing vehicle.

The radar 22 measures positions and speeds of various objects which are present in the area around the vehicle. For example, the radar 22 measures positions and speeds of an object, such as a preceding vehicle, a crossing vehicle, parked vehicles, motorcycles, pedestrians, or a falling object on the traveling road. A millimeter wave radar may be used as the radar 22, for example. This radar 22 transmits radio waves in the advancing direction of the vehicle, and receives reflected waves generated due to reflection of the transmitted waves on an object. Then, based on the transmitted waves and the received waves, the radar 22 measures a distance between the vehicle and the object (an inter-vehicle distance, for example) and the relative speed of the object with respect to the vehicle.

Note that a laser radar may be used as the radar 22 in place of the millimeter wave radar, or an ultrasonic sensor or another sensor may also be used in place of the radar 22. Further, the position and the speed of an object may also be measured by using the plurality of sensors in combination.

The vehicle speed sensor 23 detects the speed of the vehicle (vehicle speed). The acceleration sensor 24 detects acceleration of the vehicle. The yaw rate sensor 25 detects a yaw rate generated in the vehicle. The steering wheel angle sensor 26 detects the rotation angle (steering angle) of a steering wheel of the vehicle. The accelerator sensor 27 detects the pressing amount of an accelerator pedal. The brake sensor 28 detects the pressing amount of a brake pedal. The controller 10 can calculate the speed of an object based on the speed of the vehicle, which is detected by the vehicle speed sensor 23, and the relative speed of the object, which is detected by the radar 22.

The positioning device 29 includes a GPS receiver and/or a gyro sensor, and detects the position of the vehicle (current vehicle position information). The navigation device 30 stores map information therein, and can provide the map information to the controller 10. Based on map information and current vehicle position information, the controller 10 identifies, roads, intersections, traffic lights, buildings and the like which are present in the area around the vehicle (particularly in the advancing direction). The map information may be stored in the controller 10. Further, the map information may include information relating to the traffic zone and the traffic division of a lane.

The communication device 31 performs inter-vehicle communication with other vehicles around the own vehicle, and performs road-vehicle communication with road-side communication devices installed in the area around the own vehicle. The communication device 31 acquires, through such inter-vehicle communication and road-vehicle communication, communication data from other vehicles and traffic data (traffic congestion information, speed limit information, traffic light information and the like) from transportation infrastructure, and the communication device 31 outputs these data to the controller 10.

The manipulation device 32 (a user interface, tactile and/or visual controlled such as a touch panel) is an input device which is provided in a cabin, and which is operated by a driver for performing various settings relating to the vehicle. For example, the manipulation device 32 includes switches and buttons provided to an instrument panel, a dash panel, and a center console, a touch panel provided to a display device and the like. The manipulation device 32 outputs a manipulation signal which corresponds to the manipulation of the driver to the controller 10. In this embodiment, the manipulation device 32 is configured to be capable of switching between ON and OFF of a control for assisting traveling of the vehicle, and to be capable of adjusting contents of control for assisting traveling of the vehicle. For example, operating the manipulation device 32 allows the driver to switch between ON and OFF of the automatic brake for avoiding a collision between the own vehicle and an object, to perform various setting relating to a virtual area which is used when the automatic brake is performed, to perform setting of warning timing for avoiding a collision between the own vehicle and the object, and to switch between ON and OFF of a control for causing the steering wheel to be vibrated for avoiding a collision between the own vehicle and the object.

Note that at least one of the camera 21, the radar 22 and the communication device 31 is one example of a “crossing vehicle detection sensor” according to the present disclosure. Further, at least one of the camera 21 and the communication device 31 is one example of “direction indicator detection sensor” according to the present disclosure.

The engine control device 51 controls the engine of the vehicle. The engine control device 51 is a component which can adjust an engine output (driving force). For example, the engine control device 51 includes a variable valve train and the like which vary opening/closing timing of a spark plug, a fuel injection valve, a throttle valve, and an intake and exhaust valve. When it is necessary to cause the vehicle to accelerate or decelerate, the controller 10 transmits, to the engine control device 51, a control signal to change an engine output.

The brake control device 52 controls the braking device of the vehicle. The brake control device 52 is a component which can adjust a braking force generated by the braking device, and includes brake actuators, such as a hydraulic pump and a valve unit, for example. When it is necessary to cause the vehicle to decelerate, the controller 10 transmits, to the brake control device 52, a control signal to generate a braking force.

The steering control device 53 controls the steering device of the vehicle. The steering control device 53 is a component which can adjust the steering angle of the vehicle, and includes an electric motor and the like of an electric power steering system, for example. When it is necessary to change the advancing direction of the vehicle, the controller 10 transmits, to the steering control device 53, a control signal to change a steering direction.

The warning control device 54 controls a warning device which can issue a predetermined warning to a driver. This warning device may be the display device, a speaker and the like provided to the vehicle. For example, when a possibility of a collision of the own vehicle with an object increases, the controller 10 transmits a control signal to the warning control device 54 to issue a warning from the warning device. In this example, the controller 10 causes an image for notifying a high possibility of a collision with the object to be displayed on the display device, or causes voice for notifying a high possibility of a collision with the object to be outputted from the speaker.

### Automatic Brake Control

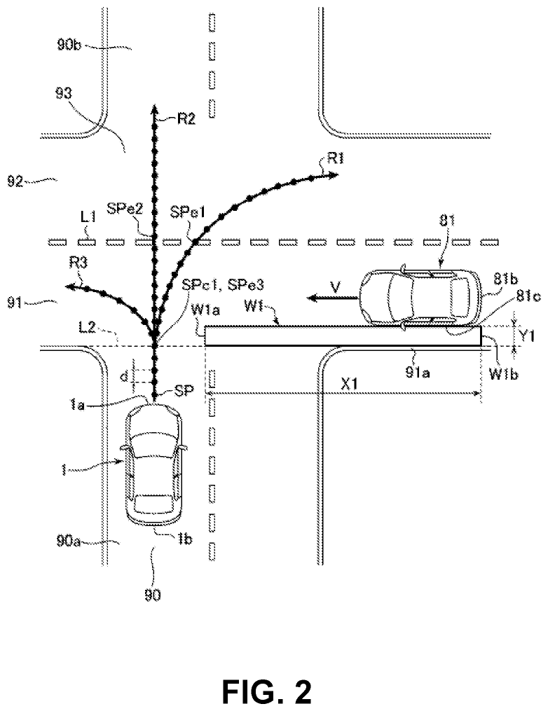

Next, the automatic brake control according to the embodiment will be described. In this embodiment, when the own vehicle enters an intersecting lane (the intersecting lane meaning a lane intersecting with an own-vehicle lane at an intersection when the own vehicle traveling in the own-vehicle lane approaches the intersection), the controller 10 performs a control of causing the own vehicle to be automatically braked to avoid a collision between the own vehicle and a crossing vehicle traveling in the intersecting lane. FIG. 2 to FIG. 4 show an environment where, as in the case of traffic conditions in Japan, vehicles traveling in the left lane is specified by traffic regulations.

### 1. Case Where Crossing Vehicle is Approaching from Right Side

First, the description will be made, with reference to FIG. 2, with respect to an automatic brake control which is performed in the case where a crossing vehicle approaches the own vehicle from the right side (this is in reference to driving in Japan, where the driving direction would be from an opposite direction than in the US, where the crossing traffic would be from the left side). FIG. 2 is an explanatory view of the automatic brake control according to the embodiment.

An own-vehicle lane 90 intersects with two lanes at an intersection 93, and is divided into a first portion 90a and a second portion 90b. Hereinafter, of the two lanes which intersect with the own-vehicle lane 90, a lane closer to the first portion 90a is referred to as “first intersecting lane 91”, and a lane closer to the second portion 90b is referred to as “second intersecting lane 92”. Each of the first intersecting lane 91 and the second intersecting lane 92 is one example of the “intersecting lane” according to the present disclosure, and is defined by a division line L1.

The controller 10 sets a plurality of sampling points SP along the intended path of an own vehicle 1 (that is, a path through which the own vehicle 1 passes in the future). The sampling points SP are virtual points, and are arranged at intervals d (for example, 10 cm intervals). The controller 10 detects the traveling state of the own vehicle 1 (for example, speed, acceleration, and posture of the own vehicle 1) at each sampling point SP, and controls the engine and the brake of the own vehicle 1, thus assisting traveling of the own vehicle 1 along the intended path.

The own vehicle 1 travels in the first portion 90a of the own-vehicle lane 90, and enters the intersection 93. On the other hand, a crossing vehicle 81 is attempting to enter the intersection 93 while traveling in the first intersecting lane 91 at a speed V (absolute value). That is, the crossing vehicle 81 is approaching the own vehicle 1 from the right side of the own vehicle 1.

In such a situation, the controller 10 controls the automatic brake such that a collision between the own vehicle 1 and the crossing vehicle 81 is avoided. The controller 10 sets a virtual area W1 in this control operation.

### 1-1. Virtual Area in Case Where Own Vehicle Turns Right at Intersection

The description will be made with respect to the case where, as in the case of an intended path R1 shown in FIG. 2, the own vehicle 1 turns right at the intersection 93. The own vehicle 1 changes the advancing direction thereof to the rightward direction while entering the first intersecting lane 91. Then, the own vehicle 1 passes through the first intersecting lane 91, and merges into the second intersecting lane 92. (While the present example is made with reference to traffic rules in Japan, the teachings of the present disclosure apply equally well as adapted to driving rules in the US where vehicles travel in the right lane.)

The virtual area W1 is a virtual object which is set to avoid a collision between the own vehicle 1 and the crossing vehicle 81, and which forms an application object of an automatic brake control. The virtual area W1 is set between the own vehicle 1 and the crossing vehicle 81, and extends in the advancing direction of the crossing vehicle 81 along an end portion 91a of the first intersecting lane 91. The end portion 91a of the first intersecting lane 91 is defined based on curbstones or a white line provided to the first intersecting lane 91, for example. For the portion of the first intersecting lane 91 to which the own-vehicle lane 90 is connected, the controller 10 sets a virtual extension L2 extending along the end portion 91a, and sets the virtual area W1 along the extension L2. The virtual area W1 has a length X1 specified by a front end W1a on the own vehicle 1 side and a rear end W1b on the crossing vehicle 81 side (that is, a length from the front end W1a to the rear end W1b). The rear end W1b is set at a position which corresponds to a rear end 81b of the crossing vehicle 81.

The controller 10 sets the length X1 of the virtual area W1 corresponding to the time required for the own vehicle 1 to finish passing through the first intersecting lane 91 while turning right. Specifically, the controller 10 first calculates a time te1 required for the own vehicle 1 to finish passing through the first intersecting lane 91 (in other words, the time required for the own vehicle 1 to finish merging into the second intersecting lane 92). To be more specific, the controller 10 first identifies one sampling point SP present on the division line L1 from a plurality of sampling points SP arranged along the intended path R1 of the own vehicle 1. When the sampling point SP is not present on the division line L1, the controller 10 identifies the sampling point SP which is present on the second intersecting lane 92 and which is closest to the division line L1. Hereinafter, the sampling point SP identified as described above is referred to as “sampling point SPe1”. Further, the controller 10 calculates the time required for a rear end 1b of the own vehicle 1 to arrive at the sampling point SPe1 as the time te1 required for the own vehicle 1 to finish passing through the first intersecting lane 91.

The controller 10 sets the length X1 based on the formula expressed by “X1=V×te1”. That is, the controller 10 sets the length X1 of the virtual area W1 to a value which corresponds to the time te1 required for the own vehicle 1 to finish passing through the first intersecting lane 91 and to the speed V of the crossing vehicle 81.

The controller 10 also sets the virtual area W1 between the crossing vehicle 81 and the end portion 91a of the first intersecting lane 91. To be more specific, the virtual area W1 has a width Y1 ranging from a side surface portion 81c of the crossing vehicle 81 to the end portion 91a of the first intersecting lane 91. The controller 10 sets the width Y1 of the virtual area W1 larger than the interval d (for example, 80 cm) at which the sampling points SP are set. With such setting, when the intended path R1 of the own vehicle 1 is present on the virtual area W1, at least one sampling point SP is present on the virtual area W1.

The side surface portion 81c is set to a position in the vicinity of the crossing vehicle 81. The position of the side surface portion 81c is not limited to the outer side surface of the crossing vehicle 81. The side surface portion 81c may be set to a position separated from the outer side surface of the crossing vehicle 81 if such a position is useful to avoid a collision between the own vehicle 1 and the crossing vehicle 81 as will be described later.

### 1-2. Virtual Area in Case Where Own Vehicle Travels Straight at Intersection

Next, the description will be made with respect to the case where, as in the case of an intended path R2 shown in FIG. 2, the own vehicle 1 travels straight at the intersection 93. Of the intended path R2, a portion from the own vehicle 1 to the extension L2 is equal to that of the above-mentioned intended path R1. The own vehicle 1 passes through the first intersecting lane 91 and the second intersecting lane 92, and enters the second portion 90b of the own-vehicle lane 90.

The controller 10 sets the length X1 of the virtual area W1 corresponding to the time required for the own vehicle 1 to finish passing through the first intersecting lane 91 while traveling straight. Specifically, the controller 10 first calculates a time te2 required for the own vehicle 1 to finish passing through the first intersecting lane 91 (in other words, the time required for the own vehicle 1 to finish entering the second intersecting lane 92). To be more specific, the controller 10 first identifies one sampling point SP present on the division line L1 from the plurality of sampling points SP arranged along the intended path R2 of the own vehicle 1. When the sampling point SP is not present on the division line L1, the controller 10 identifies the sampling point SP which is present on the second intersecting lane 92 and which is closest to the division line L1. Hereinafter, the sampling point SP identified as described above is referred to as “sampling point SPe2”. Further, the controller 10 calculates the time required for the rear end 1b of the own vehicle 1 to arrive at the sampling point SPe2 as the time te2 required for the own vehicle 1 to finish passing through the first intersecting lane 91.

The controller 10 sets the length X1 based on the formula expressed by “X1=V×te2”. That is, the controller 10 sets the length X1 of the virtual area W1 to a value which corresponds to the time te2 required for the own vehicle 1 to finish passing through the first intersecting lane 91 and to the speed V of the crossing vehicle 81.

### 1-3. Virtual Area in Case Where Own Vehicle Turns Left at Intersection

Next, the description will be made with respect to the case where, as in the case of an intended path R3 shown in FIG. 2, the own vehicle 1 turns left at the intersection 93. Of the intended path R3, a portion from the own vehicle 1 to the extension L2 is equal to that of the above-mentioned intended path R1. The own vehicle 1 turns left at the intersection 93, and merges into the first intersecting lane 91.

The controller 10 sets the length X1 of the virtual area W1 corresponding to the time required for the own vehicle 1 to finish merging into the first intersecting lane 91 while turning left. Specifically, the controller 10 first calculates a time te3 required for the own vehicle 1 to finish merging into the first intersecting lane 91 (in other words, the time required for the own vehicle 1 to finish passing through the first portion 90a of the own-vehicle lane 90). To be more specific, the controller 10 first identifies one sampling point SP present on the extension L2 from the plurality of sampling points SP arranged along the intended path R3 of the own vehicle 1. When the sampling point SP is not present on the extension L2, the controller 10 identifies the sampling point SP which is present on the first intersecting lane 91 and which is closest to the extension L2. Hereinafter, the sampling point SP identified as described above is referred to as “sampling point SPe3”. Further, the controller 10 calculates the time required for the rear end 1b of the own vehicle 1 to arrive at the sampling point SPe3 as the time te3 required for the own vehicle 1 to finish merging into the first intersecting lane 91.

The controller 10 sets the length X1 based on the formula expressed by “X1=V×te3”. That is, the controller 10 sets the length X1 of the virtual area W1 to a value which corresponds to the time te3 required for the own vehicle 1 to finish merging into the first intersecting lane 91 and to the speed V of the crossing vehicle 81.

### 1-4. Automatic Brake Control Which Uses Virtual Area

The controller 10 causes the virtual area W1 having such a shape to move with the advance of the crossing vehicle 81 (in other words, causes the virtual area W1 to advance toward the own vehicle 1 together with the crossing vehicle 81). The controller 10 controls the automatic brake to prevent the own vehicle 1 from contacting with this virtual area W1.

Specifically, the controller 10 first identifies one sampling point SP present on the extension L2 from the plurality of sampling points SP arranged along the intended path R1 to R3 of the own vehicle 1. When the sampling point SP is not present on the extension L2, the controller 10 identifies the sampling point SP which is present on the first intersecting lane 91 and which is closest to the extension L2. Hereinafter, the sampling point SP identified as described above is referred to as “sampling point SPc1”. The sampling point SPc1 in this embodiment is equal to the above-mentioned sampling point SPe3.

The controller 10 calculates Time to Collision/predicted time to collision (TTC) of the own vehicle 1 with respect to the virtual area W1. Specifically, the controller 10 calculates the time required for a front end 1a of the own vehicle 1 to arrive at the sampling point SPc1 based on the speed and acceleration of the own vehicle 1 and the distance from the own vehicle 1 to the sampling point SPc1.

The controller 10 determines whether or not it is necessary to perform an automatic brake based on TTC calculated as described above. When the controller 10 determines that the automatic brake is necessary, the controller 10 controls the braking device via the brake control device 52 to cause the own vehicle 1 to stop without protruding to the first intersecting lane 91.

### 2. Case Where Crossing Vehicle is Approaching from Left Side

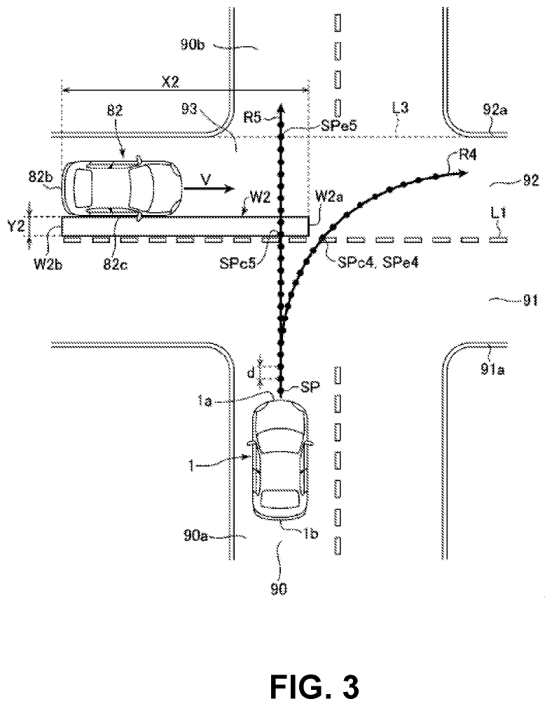

Next, the description will be made, with reference to FIG. 3, with respect to an automatic brake control which is performed in the case where a crossing vehicle approaches the own vehicle from the left side. FIG. 3 is an explanatory view of the automatic brake control according to the embodiment. The description of configurations and processes which are substantially equal to those in the above-mentioned case will be omitted when appropriate.

The own vehicle 1 travels in the first portion 90a of the own-vehicle lane 90, and enters the intersection 93. On the other hand, a crossing vehicle 82 is attempting to enter the intersection 93 while traveling in the second intersecting lane 92 at a speed V (absolute value). That is, the crossing vehicle 82 is approaching the own vehicle 1 from the left side of the own vehicle 1.

The controller 10 sets a virtual area W2 to avoid a collision between the own vehicle 1 and the crossing vehicle 82. The virtual area W2 is set between the own vehicle 1 and the crossing vehicle 82, and extends in the advancing direction of the crossing vehicle 82 along the division line L1. The virtual area W2 has a length X2 specified by a front end W2a on the own vehicle 1 side and a rear end W2b on the crossing vehicle 82 side (that is, a length from the front end W2a to the rear end W2b). The rear end W2b is set at a position which corresponds to a rear end 82b of the crossing vehicle 82.

### 2-1. Virtual Area in Case Where Own Vehicle Turns Right at Intersection

The description will be made with respect to the case where, as in the case of an intended path R4 shown in FIG. 3, the own vehicle 1 turns right at the intersection 93. The own vehicle 1 changes the advancing direction thereof to the rightward direction while entering the first intersecting lane 91. Then, the own vehicle 1 passes through the first intersecting lane 91, and merges into the second intersecting lane 92.

The controller 10 sets the length X2 of the virtual area W2 corresponding to the time required for the own vehicle 1 to finish merging into the second intersecting lane 92 while turning right. Specifically, the controller 10 first calculates the time required for the own vehicle 1 to finish merging into the second intersecting lane 92 (hereinafter referred to as “te4”). To be more specific, the controller 10 first identifies one sampling point SP present on the division line L1 from the plurality of sampling points SP arranged along the intended path R4 of the own vehicle 1. When the sampling point SP is not present on the division line L1, the controller 10 identifies the sampling point SP which is present on the second intersecting lane 92 and which is closest to the division line L1. Hereinafter, the sampling point SP identified as described above is referred to as “sampling point SPe4”. Further, the controller 10 calculates the time required for the rear end 1b of the own vehicle 1 to arrive at the sampling point SPe4 as the time te4 required for the own vehicle 1 to finish merging into the second intersecting lane 92.

The controller 10 sets the length X2 based on the formula expressed by “X2=V×te4”. That is, the controller 10 sets the length X2 of the virtual area W2 to a value which corresponds to the time te4 required for the own vehicle 1 to finish merging into the second intersecting lane 92 and to the speed V of the crossing vehicle 82.

The controller 10 also sets the virtual area W2 between the crossing vehicle 82 and the division line L1. To be more specific, the virtual area W2 has a width Y2 ranging from a side surface portion 82c of the crossing vehicle 82 to the division line L1. The controller 10 sets the width Y2 of the virtual area W2 larger than the interval d (for example, 80 cm) at which the sampling points SP are set. With such setting, when the intended path R4 of the own vehicle 1 is present on the virtual area W2, it is assumed that at least one sampling point SP is present on the virtual area W2.

### 2-2. Virtual Area in Case Where Own Vehicle Travels Straight at Intersection

Next, the description will be made with respect to the case where, as in the case of an intended path R5 shown in FIG. 3, the own vehicle 1 travels straight at the intersection 93. The own vehicle 1 passes through the first intersecting lane 91 and the second intersecting lane 92, and enters the second portion 90b of the own-vehicle lane 90.

The controller 10 sets the length X2 of the virtual area W2 corresponding to the time required for the own vehicle 1 to finish passing through the second intersecting lane 92 while traveling straight. Specifically, the controller 10 first calculates a time te5 required for the own vehicle 1 to finish passing through the second intersecting lane 92 (in other words, the time required for the own vehicle 1 to finish entering the second portion 90b of the own-vehicle lane 90). To be more specific, the controller 10 sets a virtual extension L3 extending along an end portion 92a of the second intersecting lane 92, and identifies one sampling point SP present on the extension L3 from the plurality of sampling points SP arranged along the intended path R5 of the own vehicle 1. When the sampling point SP is not present on the extension L3, the controller 10 identifies the sampling point SP which is present at the second portion 90b of the own-vehicle lane 90 and which is closest to the extension L3. Hereinafter, the sampling point SP identified as described above is referred to as “sampling point SPe5”. Further, the controller 10 calculates the time required for the rear end 1b of the own vehicle 1 to arrive at the sampling point SPe5 as the time te5 required for the own vehicle 1 to finish passing through the second intersecting lane 92.

The controller 10 sets the length X2 based on the formula expressed by “X2=V×te5”. That is, the controller 10 sets the length X2 of the virtual area W2 to a value which corresponds to the time te5 required for the own vehicle 1 to finish passing through the second intersecting lane 92 and to the speed V of the crossing vehicle 82.

### 2-3. Automatic Brake Control Which Uses Virtual Area

The controller 10 causes the virtual area W2 having such a shape to move with advance of the crossing vehicle 82 (in other words, causes the virtual area W2 to advance toward the own vehicle 1 together with the crossing vehicle 82). The controller 10 controls the automatic brake to prevent a the own vehicle 1 from contacting with this virtual area W2.

Specifically, the controller 10 first identifies one sampling point SP present on the division line L1 from the plurality of sampling points SP arranged along the intended path R4, R5 of the own vehicle 1. When the sampling point SP is not present on the division line L1, the controller 10 identifies the sampling point SP which is present on the second intersecting lane 92 and which is closest to the division line L1. Hereinafter, the sampling point SP identified as described above is referred to as “sampling point SPc4”, “sampling point SPc5”. The sampling point SPc4 in this embodiment is equal to the above-mentioned sampling point SPe4.

The controller 10 calculates TTC of the own vehicle 1 with respect to the virtual area W2. Specifically, the controller 10 calculates the time required for the front end 1a of the own vehicle 1 to arrive at the sampling point SPc4, SPc5 based on the speed and acceleration of the crossing vehicle 82 with respect to the own vehicle 1 and the distance from the own vehicle 1 to the sampling point SPc4, SPc5.

The controller 10 determines whether or not it is necessary to perform an automatic brake based on TTC calculated as described above. When the controller 10 determines that the automatic brake is necessary, the controller 10 controls the braking device via the brake control device 52, thus causing the own vehicle 1 to stop without protruding to the first intersecting lane 91.

### 3. Case Where Crossing Vehicle is Approaching from Right Side While Flashing Direction Indicator

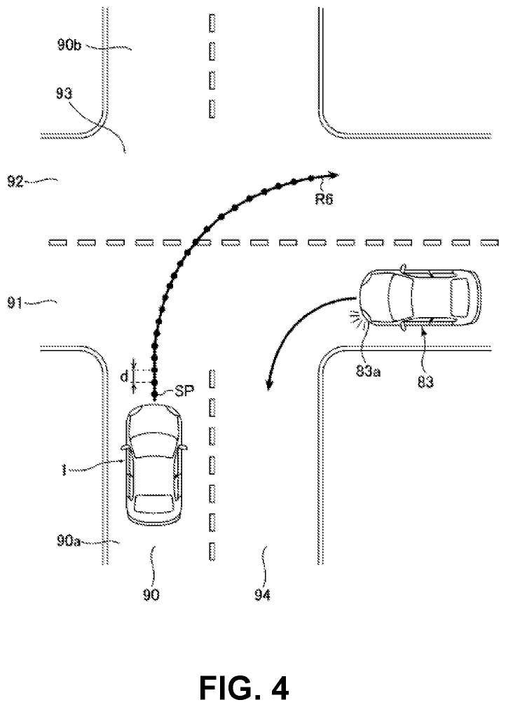

Next, the description will be made, with reference to FIG. 4, with respect to an automatic brake control which is performed in the case where a crossing vehicle approaches the own vehicle from the right side while flashing a direction indicator. FIG. 4 is an explanatory view of the automatic brake control according to the embodiment. The description of configurations and processes which are substantially equal to those in the above-mentioned case will be omitted when appropriate.

The own vehicle 1 travels in the first portion 90a of the own-vehicle lane 90, and enters the intersection 93. On the other hand, a crossing vehicle 83 is attempting to enter the intersection 93 while traveling in the first intersecting lane 91. That is, the crossing vehicle 83 is approaching the own vehicle 1 from the right side of the own vehicle 1.

As in the case of an intended path R6 shown in FIG. 4, the own vehicle 1 is attempting to turn right at the intersection 93. On the other hand, the crossing vehicle 83 is approaching while flashing a direction indicator 83a of the crossing vehicle 83.

In such a case, it is anticipated that the crossing vehicle 83 does not travel straight at the intersection 93 thereafter. That is, as the intension to change the advancing direction indicated by flashing the direction indicator 83a, it is anticipated that the crossing vehicle 83 turns left at the intersection 93, and enters another lane 94. In this case, a possibility of a collision of the own vehicle 1 with the crossing vehicle 83 is relatively low and hence, the controller 10 does not cause an automatic brake to be operated.

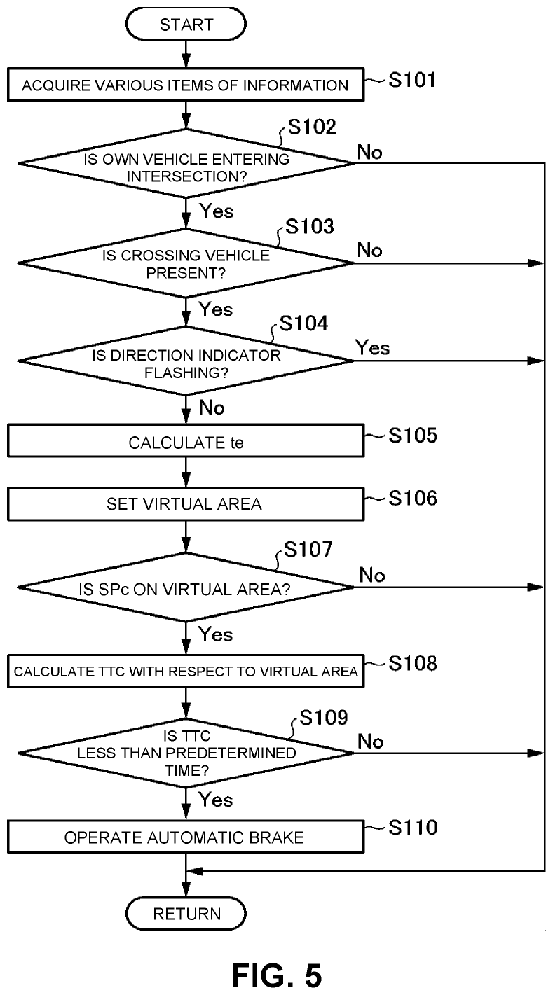

Next, the process performed by the controller 10 will be described with reference to FIG. 5. FIG. 5 is a flowchart showing a process performed by the controller 10 according to the embodiment. The controller 10 repeatedly performs the process of the flowchart in a predetermined cycle (in a 100 ms cycle, for example).

First, in step S101, the controller 10 acquires various items of information from the above-mentioned plurality of sensors and switches. Specifically, the controller 10 acquires various items of information based on signals inputted from the camera 21, the radar 22, the vehicle speed sensor 23, the acceleration sensor 24, the yaw rate sensor 25, the steering wheel angle sensor 26, the accelerator sensor 27, the brake sensor 28, the positioning device 29, the navigation device 30, the communication device 31, and the manipulation device 32.

Next, in step S102, the controller 10 determines whether or not the own vehicle 1 is attempting to enter the intersection. Specifically, the controller 10 determines whether or not an intersection is present in the vicinity of the own vehicle 1 and in the advancing direction of the own vehicle 1 based on signals (which correspond to image data) inputted from the camera 21, signals (which correspond to map information and current vehicle position information) inputted from the navigation device 30, and signals (which correspond to road-vehicle communication) inputted from the communication device 31. When it is determined that the own vehicle 1 is attempting to enter the intersection (step S102: Yes), the controller 10 advances the process to step S103. On the other hand, when it is not determined that the own vehicle 1 is attempting to enter the intersection (step S102: No), the controller 10 causes the process to skip a series of routines shown in this flowchart.

Next, in step S103, the controller 10 determines whether or not a crossing vehicle 8 (which corresponds to the above-mentioned crossing vehicle 81 to 83) approaching the own vehicle 1 while traveling in the intersecting lane is present. Specifically, based on signals (which correspond to image data) inputted from the camera 21, signals inputted from the radar 22, signals (signals which correspond to inter-vehicle communication) inputted from the communication device 31 or other signals, the controller 10 performs a process for detecting the crossing vehicle 8 approaching the own vehicle 1. As a result, when the crossing vehicle 8 approaching the own vehicle 1 is detected, the controller 10 determines that the crossing vehicle 8 is present (step S103: Yes), and the process advances to step S104. On the other hand, when the crossing vehicle 8 approaching the own vehicle 1 is not detected, the controller 10 determines that the crossing vehicle 8 is not present (step S103: No) so that the process skips the series of routines shown in this flowchart.

Next, in step S104, the controller 10 determines whether or not the direction indicator of the crossing vehicle 8 (which corresponds to the above-mentioned direction indicator 83a of the crossing vehicle 83) is flashing. Specifically, based on signals (signals which correspond to image data) inputted from the camera 21, signals (signals which correspond to inter-vehicle communication) inputted from the communication device 31 or other signals, the controller 10 performs a process for detecting flashing of the direction indicator. As a result, when the flashing of the direction indicator of the crossing vehicle 8 is not detected, the controller 10 determines that the direction indicator of the crossing vehicle 8 is not flashing (step S104: No), and the process advances to step S105. On the other hand, when the flashing of the direction indicator is detected, the controller 10 determines that the direction indicator is flashing (step S104: Yes) so that the process skips the series of routines shown in this flowchart.

Next, in step S105, the controller 10 calculates the time te (which corresponds to the above-mentioned time te1 to te5) required for the own vehicle 1 to arrive at the sampling point SPe (which corresponds to the above-mentioned sampling point SPe1 to SPe5) on the intended path R (which corresponds to the above-mentioned intended path R1 to R5). That is, the controller 10 calculates the time te (which corresponds to the above-mentioned time te1, te2, te5) required for the own vehicle 1 to finish passing through the intersecting lane where the crossing vehicle 8 is traveling, or the time te (which corresponds to the above-mentioned time te3, te4) required for the own vehicle 1 to finish merging into the intersecting lane where the crossing vehicle 8 is traveling. Specifically, the controller 10 first identifies one sampling point SPe as described above from the plurality of sampling points SP set along the intended path R. Then, the controller 10 calculates the time te required for the rear end 1b of the own vehicle 1 to arrive at the sampling point SPe based on the speed of the own vehicle 1 and the like.

Next, in step S106, the controller 10 sets the virtual area W (which corresponds to the above-mentioned virtual area W1, W2) based on the speed V of the crossing vehicle 8 and the time te calculated as described above. Specifically, the controller 10 sets the virtual area W which extends from a rear end 8b (which corresponds to the above-mentioned rear end 81b, 82b) of the crossing vehicle 8 in the advancing direction of the crossing vehicle 8 by a length X (which corresponds to the above-mentioned length X1, X2), and which has the width Y (which corresponds to the above-mentioned width Y1, Y2).

Next, in step S107, the controller 10 determines whether or not the sampling point SPc (which corresponds to the above-mentioned sampling point SPc1, SPc4, SPc5) is present on the virtual area W. In other words, the controller 10 determines whether or not the virtual area W (particularly, the front end of the virtual area W) arrives at the sampling point SPc due to advance of the crossing vehicle 8. Specifically, the controller 10 performs the determination in step S107 based on the position of the sampling point SPc identified as described above and the position of the front end of the virtual area W. As a result, when it is determined that the sampling point SPc is present on the virtual area W (step S107: Yes), the controller 10 advances the process to step S108.

On the other hand, when it is not determined in step S107 that the sampling point SPc is present on the virtual area W (step S107: No), the controller 10 causes the process to skip the series of routines shown in this flowchart. When the sampling point SPc is not present on the virtual area W as described above, the crossing vehicle 8 is sufficiently separated from the own vehicle 1, that is, there is no possibility of a collision with the crossing vehicle 8 even if the own vehicle 1 enters the intersecting lane. Accordingly, the controller 10 does not perform an automatic brake control based on the virtual area W.

Next, in step S108, the controller 10 calculates TTC of the own vehicle 1 with respect to the virtual area W. Specifically, it is assumed that the own vehicle 1 collides with the virtual area W when the front end 1a of the own vehicle 1 arrives at the sampling point SPc. Accordingly, the controller 10 uses the time required for the front end 1a of the own vehicle 1 to arrive at the sampling point SPc as TTC.

Next, in step S109, the controller 10 determines whether or not TTC calculated as described above is less than a predetermined time. The predetermined time is a threshold of TTC which specifies timing at which the operation of the automatic brake should be started to cause the own vehicle 1 to stop without entering the intersection. The predetermined time is set by a predetermined arithmetic expression, a simulation, an experiment or the like (the predetermined time may be a fixed value or a variable value).

As a result of step S109, when it is determined that TTC is less than the predetermined time (step S109: Yes), the controller 10 advances the process to step S110. In step S110, the controller 10 controls the braking device via the brake control device 52 to cause the automatic brake to be operated, that is, to cause the own vehicle 1 to be automatically braked. With such control, a braking force is applied to the own vehicle 1 to decelerate the own vehicle 1 and hence, the own vehicle 1 is stopped in front of the virtual area W.

Note that the controller 10 may control the warning control device 54 such that a warning is issued from the warning device when the automatic brake is operated as described above. That is, the controller 10 may cause an image and/or voice for a notification of high possibility of a collision with the crossing vehicle to be outputted on/from the display device and/or the speaker with the operation of the automatic brake. For example, it is preferable to issue a warning from the warning device before the automatic brake is operated.

On the other hand, as a result of step S109, when it is not determined that TTC is less than the predetermined time (step S109: No), that is, when TTC is the predetermined time or more, the controller 10 causes the process to skip the series of routines shown in this flowchart. In this case, the controller 10 does not cause the automatic brake to be operated.

Next, the manner of operation and advantageous effects according to the embodiment will be described.

According to this configuration, the controller 10 sets the virtual area W. The virtual area W is set to avoid a collision between the own vehicle 1 and the crossing vehicle 8 (which corresponds to the above-mentioned crossing vehicle 81, 82), and the virtual area W is an application object of a control of causing the own vehicle 1 to be automatically braked.

Specifically, the controller 10 sets, between the own vehicle 1 and the crossing vehicle 8, the virtual area W which moves with the advance of the crossing vehicle 8 and which extends in the advancing direction of the crossing vehicle 8, and the controller 10 performs a control of causing the own vehicle 1 to be automatically braked to prevent a the own vehicle 1 from contacting with the virtual area W. With such a configuration, it is possible to cause the own vehicle 1 to be stopped at a position relatively separated from the crossing vehicle 8 to avoid a collision between the own vehicle 1 and the crossing vehicle 8.

Further, the controller 10 is configured to set the virtual area W having the length X which corresponds to the time te (which corresponds to the above-mentioned time te1, te2, te5) required for the own vehicle 1 to finish passing through the intersecting lane where the crossing vehicle 8 is traveling, or which corresponds to the time te (which corresponds to the above-mentioned time te3, te4) required for the own vehicle 1 to finish merging into the intersecting lane where the crossing vehicle 8 is traveling. According to this configuration, the controller 10 can set the length X of the virtual area W to a value which corresponds to the time required for the own vehicle 1 to finish moving to a position where a collision with the crossing vehicle 8 can be avoided. By setting the virtual area W having such a length, it is possible to avoid a collision between the own vehicle 1 and the crossing vehicle 8 with certainty.

Further, the controller 10 is configured to set the length X of the virtual area W based on a distance acquired by multiplying the speed V of the crossing vehicle 8 by the time te (which corresponds to the above-mentioned time te1, te2, te5) required for the own vehicle 1 to finish passing through the intersecting lane where the crossing vehicle 8 is traveling, or by the time (which corresponds to the above-mentioned time te3, te4) required for the own vehicle 1 to finish merging into the intersecting lane where the crossing vehicle 8 is traveling. According to this configuration, the controller 10 can set the length X of the virtual area W to a value which corresponds to the time te required for the own vehicle 1 to finish moving to a position where a collision with the crossing vehicle 8 can be avoided, and which corresponds to the speed V of the crossing vehicle 8. By setting the virtual area W having such a length X, it is possible to avoid a collision between the own vehicle 1 and the crossing vehicle 8 with certainty.

Further, the controller 10 is configured to perform a control of causing the own vehicle 1 to be automatically braked to prevent the own vehicle 1 from entering the intersection. According to this configuration, it is possible to dispose the own vehicle 1 at a safer position while a collision between the own vehicle 1 and the crossing vehicle 8 is avoided.

Further, the controller 10 sets the plurality of sampling points SP at intervals d along the intended path R of the own vehicle 1. The controller 10 is configured to perform, based on one sampling point SPc and the virtual area W, a control of causing the own vehicle 1 to be automatically braked to prevent the own vehicle 1 from contacting with the virtual area W, and the controller 10 sets the width Y of the virtual area W larger than the interval d. According to this configuration, the sampling point SP is used in a control of causing the own vehicle 1 to be automatically braked to prevent the own vehicle 1 from contacting with the virtual area W, and the width Y of the virtual area W is set larger than the interval d at which the plurality of sampling points SP are set. With such setting, even in the case where the intended path R extends in the width direction of the virtual area W, based on the sampling point SP and the virtual area W, it is possible to detect that the intended path R of the own vehicle 1 is present on the virtual area W and hence, a collision between the own vehicle 1 and the crossing vehicle 8 can be avoided with certainty.

Further, the vehicle control device 100 includes the camera 21 and the communication device 31 which detects flashing of the direction indicator of the crossing vehicle 8. The controller 10 is configured not to perform a control of causing the own vehicle 1 to be automatically braked to prevent the own vehicle 1 from contacting with the virtual area W when the camera 21 or the communication device 31 detects flashing of the direction indicator of the crossing vehicle 8. According to this configuration, the controller 10 does not set the virtual area W when a possibility of an actual collision of the own vehicle 1 with the crossing vehicle 8 is low. Accordingly, it is possible to avoid a collision between the own vehicle 1 and the crossing vehicle 8 while inhibiting that the own vehicle 1 is unnecessarily automatically braked.

The above-mentioned embodiment is directed to the automatic brake control at the intersection 93 having a cross shape. However, the present disclosure is not limited to such a mode. For example, the present disclosure is also applicable to the own vehicle which enters an intersection, such as a so-called “T-intersection”.

The following description relates to a computer environment in which embodiments of the present disclosure may be implemented. This environment may include an embedded computer environment, local multi-processor embodiment, remote (e.g., cloud-based) environment, or a mixture of all the environments.

FIG. 6 illustrates a block diagram of a computer that may implement the various embodiments described herein. The present disclosure may be embodied as a system, a method, and/or a computer program product. The computer program product may include a computer readable storage medium on which computer readable program instructions are recorded that may cause one or more processors to carry out aspects of the embodiment.

The non-transitory computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 6 is a functional block diagram illustrating a networked system 800 of one or more networked computers and servers. In an embodiment, the hardware and software environment illustrated in FIG. 6 may provide an exemplary platform for implementation of the software and/or methods according to the present disclosure. Referring to FIG. 6, a networked system 800 may include, but is not limited to, computer 805, network 810, remote computer 815, web server 820, cloud storage server 825 and compute server 830. In some embodiments, multiple instances of one or more of the functional blocks illustrated in FIG. 6 may be employed. Additional detail of computer 805 is shown in FIG. 6. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC). Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and compute server 830.

### REFERENCE SIGNS LIST

1 own vehicle
10 controller
21 camera (crossing vehicle detection sensor, direction indicator detection sensor)
22 radar (crossing vehicle detection sensor)
31 communication device (crossing vehicle detection sensor, direction indicator detection sensor)
81, 82 crossing vehicle
90 own-vehicle lane
91 first intersecting lane (intersecting lane)
92 second intersecting lane (intersecting lane)
93 intersection
100 vehicle control device
SP sampling point
W1, W2 virtual area

What is claimed is:

1. A vehicle control device comprising:
a crossing vehicle detection sensor configured to detect a crossing vehicle approaching an own vehicle while the own vehicle is traveling in an intersecting lane, the intersecting lane being a lane that intersects an own vehicle lane at an intersection at a time the own vehicle approaches the intersection, the crossing vehicle being a vehicle travelling in the intersecting lane; and
a controller configured to automatically brake the own vehicle to avoid a collision between the own vehicle and the crossing vehicle under a condition that the own vehicle enters the intersecting lane, wherein
the controller is configured to
set, between the own vehicle and the crossing vehicle, a virtual area that moves with the crossing vehicle and that extends in an advancing direction of the crossing vehicle, and
automatically brake the own vehicle to prevent the own vehicle from contacting the virtual area.

2. The vehicle control device according to claim 1, wherein the controller is configured to set the virtual area having a length that corresponds to
a time required for the own vehicle to finish passing through the intersecting lane in which the crossing vehicle travels, or
a time required for the own vehicle to finish merging into the intersecting lane in which the crossing vehicle travels.

3. The vehicle control device according to claim 2, wherein the controller is configured to set the length of the virtual area based on a distance obtained by multiplying a speed of the crossing vehicle by
the time required for the own vehicle to finish passing through the intersecting lane where the crossing vehicle travels, or
the time required for the own vehicle to finish merging into the intersecting lane where the crossing vehicle travels.

4. The vehicle control device according to claim 1, wherein the controller is configured to automatically brake the own vehicle to prevent the own vehicle from entering the intersection.

5. The vehicle control device according to claim 1, wherein the controller is configured to
set a plurality of sampling points along an intended path of the own vehicle at predetermined intervals and, based on at least one of the plurality of sampling points and the virtual area, automatically brake the own vehicle to prevent the own vehicle from contacting the virtual area, and
set a width of the virtual area larger than the each of predetermined intervals.

6. The vehicle control device according to claim 1, further comprising:
a direction indicator detection sensor configured to detect a flashing of a direction indicator of the crossing vehicle, wherein
the controller is configured to not set the virtual area in a condition where the direction indicator detection sensor detects the flashing of the direction indicator of the crossing vehicle.

7. The vehicle control device according to claim 2, wherein the controller is configured to automatically brake the own vehicle to prevent the own vehicle from entering the intersection.

8. The vehicle control device according to claim 2, wherein the controller is configured to
set a plurality of sampling points along an intended path of the own vehicle at predetermined intervals and, based on at least one of the plurality of sampling points and the virtual area, automatically brake the own vehicle to prevent the own vehicle from contacting the virtual area, and
set a width of the virtual area larger than the each of predetermined intervals.

9. The vehicle control device according to claim 2, further comprising:
a direction indicator detection sensor configured to detect a flashing of a direction indicator of the crossing vehicle, wherein
the controller is configured to not set the virtual area in a condition where the direction indicator detection sensor detects the flashing of the direction indicator of the crossing vehicle.

10. A vehicle control method comprising:
detecting with a crossing vehicle detection sensor a crossing vehicle approaching an own vehicle while the own vehicle is traveling in an intersecting lane, the intersecting lane being a lane that intersects an own vehicle lane at an intersection at a time the own vehicle approaches the intersection, the crossing vehicle being a vehicle travelling in the intersecting lane;
automatically braking the own vehicle to avoid a collision between the own vehicle and the crossing vehicle under a condition that the own vehicle enters the intersecting lane;
setting, between the own vehicle and the crossing vehicle, a virtual area that moves with the crossing vehicle and that extends in an advancing direction of the crossing vehicle; and
automatically braking the own vehicle to prevent the own vehicle from contacting the virtual area.

11. The vehicle control method according to claim 10, wherein the setting includes setting the virtual area having a length that corresponds to
a time required for the own vehicle to finish passing through the intersecting lane in which the crossing vehicle travels, or
a time required for the own vehicle to finish merging into the intersecting lane in which the crossing vehicle travels.

12. The vehicle control method according to claim 11, wherein the setting includes setting the length of the virtual area based on a distance obtained by multiplying a speed of the crossing vehicle by
the time required for the own vehicle to finish passing through the intersecting lane where the crossing vehicle travels, or
the time required for the own vehicle to finish merging into the intersecting lane where the crossing vehicle travels.

13. The vehicle control method according to claim 10, wherein the automatically braking includes applying brakes of the own vehicle to prevent the own vehicle from entering the intersection.

14. The vehicle control method according to claim 10, wherein the setting includes
setting a plurality of sampling points along an intended path of the own vehicle at predetermined intervals and, based on at least one of the plurality of sampling points and the virtual area, automatically braking the own vehicle to prevent the own vehicle from contacting the virtual area, and
setting a width of the virtual area larger than the each of predetermined intervals.

15. The vehicle control method according to claim 10, further comprising:
detecting with a direction indicator detection sensor a flashing of a direction indicator of the crossing vehicle, wherein
the setting includes not setting the virtual area in a condition where the direction indicator detection sensor detects the flashing of the direction indicator of the crossing vehicle.

16. The vehicle control method according to claim 11, wherein the automatically braking includes applying brakes to the own vehicle to prevent the own vehicle from entering the intersection.

17. The vehicle control method according to claim 11, wherein the setting includes
setting a plurality of sampling points along an intended path of the own vehicle at predetermined intervals and, based on at least one of the plurality of sampling points and the virtual area, automatically braking the own vehicle to prevent the own vehicle from contacting the virtual area, and
setting a width of the virtual area larger than the each of predetermined intervals.

18. The vehicle control method according to claim 11, further comprising:
detecting with a direction indicator detection sensor a flashing of a direction indicator of the crossing vehicle, wherein
the setting includes not setting the virtual area in a condition where the direction indicator detection sensor detects the flashing of the direction indicator of the crossing vehicle.

19. A non-transitory computer readable storage including computer readable instructions that when executed by a controller cause the controller to execute a vehicle control method, the method comprising:
detecting with a crossing vehicle detection sensor a crossing vehicle approaching an own vehicle while the own vehicle is traveling in an intersecting lane, the intersecting lane being a lane that intersects an own vehicle lane at an intersection at a time the own vehicle approaches the intersection, the crossing vehicle being a vehicle travelling in the intersecting lane;
automatically braking the own vehicle to avoid a collision between the own vehicle and the crossing vehicle under a condition that the own vehicle enters the intersecting lane;
setting, between the own vehicle and the crossing vehicle, a virtual area that moves with the crossing vehicle and that extends in an advancing direction of the crossing vehicle; and
automatically braking the own vehicle to prevent the own vehicle from contacting the virtual area.

20. The non-transitory computer readable storage of claim 19, wherein the setting includes setting the virtual area having a length that corresponds to
a time required for the own vehicle to finish passing through the intersecting lane in which the crossing vehicle travels, or
a time required for the own vehicle to finish merging into the intersecting lane in which the crossing vehicle travels.
